(19) United States
(12) Patent Application Publication
(10) Pub. No.: US 2007/0217814 A1
(43) Pub. Date: Sep. 20, 2007

(54) Systems and methods for imaging cartridge conversion

(75) Inventors: Anthony D. Causey, Fuquay-Varina, NC (US); James H. Jones, Fayetteville, NC (US); Andrew D. Scott, Robbins, NC (US); Chad A. Wright, Raleigh, NC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 11/375,739

(22) Filed: Mar. 15, 2006

(51) Int. Cl. G03G 15/00

(52) U.S. Cl. 399/109

(57) ABSTRACT

A method and tool for converting one imaging cartridge type to another is disclosed. The method includes providing the imaging cartridge comprising an upper half and a lower half, the imaging cartridge not having a waste bin assembly, the imaging cartridge operable in a first type of imaging device and not operable in a second type of imaging device; and altering a physical characteristic of said upper half to form an altered imaging cartridge operable in the second type of imaging device.

### FIELD OF THE INVENTION

The present invention relates to imaging components and more specifically to a methods of converting one type of imaging cartridge into another.

### BACKGROUND OF THE INVENTION

Printer cartridges are typically designed to provide the consumer a certain number of print copies before the toner or ink is exhausted. The total number of prints varies depending on the type, quality and density of the print. After all of the toner or ink is spent, the cartridges are either thrown away or recycled.

An emerging industry has developed that deals with the recycling of printer cartridges. Typically, the cartridge remanufacturer receives spent printer cartridges and refurbishes them. The refurbishment process entails replacing the worn or nonfunctioning parts and refilling the cartridge with either toner or ink.

Toner cartridges are typically designed to fit into one type of laser printer or family of laser printers. For example, the same toner cartridge may be used in an HP4200 or HP4300 monochrome laser printer. As new printer models are introduced, the printer manufacturer may decide to alter the physical characteristics of the printer cartridge. In some cases the alteration may be an entirely new shape or the printer manufacturer may only change a minor detail such as an indentation on the cartridge.

Additionally, toner cartridges produced by different printer manufacturers may have very similar physical characteristics. Similar toner cartridges may be used in different printers by undergoing a physical conversion process. This is especially advantageous for the toner cartridge remanufacturer if toner cartridges of one type are readily available. By modifying the more inexpensive and plentiful toner cartridge, the toner cartridge remanufacturer may produce a refurbished altered toner cartridge useable in various printers.

A typical toner cartridge comprises an assembled plastic housing. The material of the housing may be molded plastic or other plastic composite. During the remanufacturing of the cartridge, the cartridge is disassembled, cleaned, refurbished and reassembled. The last step of the refurbishment process includes refilling the cartridge with toner and the cartridge is repackaged.

The present invention is intended for use in cartridges that are toner efficient and do not require a waste bin assembly.

### SUMMARY OF THE INVENTION

A method of converting an imaging cartridge from one type to another comprising providing the imaging cartridge comprising an upper half and a lower half, said imaging cartridge not having a waste bin assembly, said imaging cartridge operable in a first type of imaging device and not operable in a second type of imaging device, and altering a physical characteristic of said upper half to form an altered imaging cartridge operable in the second type of imaging device.

A method of converting an imaging cartridge from one type to another comprising providing the imaging cartridge comprising an upper half and a lower half, providing the imaging cartridge comprising an upper half and a lower half, said imaging cartridge not comprising a waste bin assembly, said imaging cartridge operable in a first type of imaging device and not operable in a second type of imaging device, separating said upper half from said lower half, replacing said upper half with a replacement upper half comprising at least one different physical characteristic than said upper half; and reassembling said imaging cartridge.

A refurbished printer cartridge comprising a first portion and a second portion, said first portion separable from said second portion, said first portion having different physical characteristics than an original portion, wherein said printer cartridge does not have a waste bin assembly.

### BRIEF DESCRIPTION OF THE DRAWINGS

The invention is further described in the detailed description that follows, by reference to the noted drawings by way of non-limiting illustrative embodiments of the invention, in which like reference numerals represent similar elements throughout the several views of the drawings, and wherein:

FIG. 1 shows an exploded front perspective view of an older style toner cartridge with no key slots.

FIG. 2 shows a front perspective view of an upper half of a toner cartridge with only two key slots

FIG. 3 shows a front perspective view of an upper half of a toner cartridge with multiple key slots

FIG. 4 shows a conversion tool for use in converting the toner cartridge of FIG. 1.

FIGS. 5 and 6 display conversion charts for converting toner cartridges in accordance with the present invention.

### DETAILED DESCRIPTION

The following detailed description of preferred embodiments refers to the accompanying drawings which illustrate specific embodiments of the invention. In the discussion that follows, specific systems and techniques for repairing, manufacturing or remanufacturing an imaging cartridge, such as a toner cartridge. Other embodiments having different structures and operations for the repair, remanufacture and operation of other types of replaceable imaging components and for various types of imaging devices, such as laser printers, inkjet printers, copiers, facsimile machines and the like, do not depart from the scope of the present invention.

Within the printer industry, printer manufacturers have employed various techniques to differentiate between toner cartridges used in different printers. These techniques range from the obvious altering of the physical dimensions and shape of the toner cartridge to very subtle indentations at certain locations on the toner cartridge. For example, some printer manufacturers have installed fins or keys that protrude against the toner cartridge when the cartridge is installed inside the printer.

As new printer models are developed, “new” toner cartridges may also be introduced. In some cases, the new cartridge may contain exactly the same components as the toner cartridge of the previous printer model. However, the new toner cartridge may have slightly different physical packaging. In some cases, the printer manufacturer may install indentations into the printer cartridge to receive the fins or keys when the toner cartridge is inserted into the printer. Changing the orientation or location of the fins allows the printer manufacturer to differentiate between a previously introduced cartridge and a “new” toner cartridge. This may allow the printer manufacturer to increase his margins by charging the consumer a premium for the new cartridge while taking advantage of the existing technology.

Different printer manufacturers may take advantage of existing toner cartridge technology by using an existing toner cartridge design and making only slight physical modifications. For instance, a toner cartridge manufactured by Samsung may be physically similar to a toner cartridge manufactured by Xerox. In some cases, the only packaging difference between the two cartridges is the location of the indentations on the toner cartridge.

In the toner cartridge refurbishment industry, the used toner cartridges are collected and serviced by toner cartridge remanufacturers. The first step in the refurbishment process is the disassembling of the spent cartridges. Next, the internal components are separated. Non-functioning components are replaced, and the remaining components, as well as the body of the cartridge undergo a cleaning process. In the final step the toner cartridge is reassembled and new toner is added. The refurbished cartridge is then packaged and distributed to the consumer.

Part of the refurbishment process may include making physical alterations to the cartridge. For example, older cartridges may be altered or converted into “new” cartridge types. The present invention provides a way of converting a printer toner cartridge of one type into another.

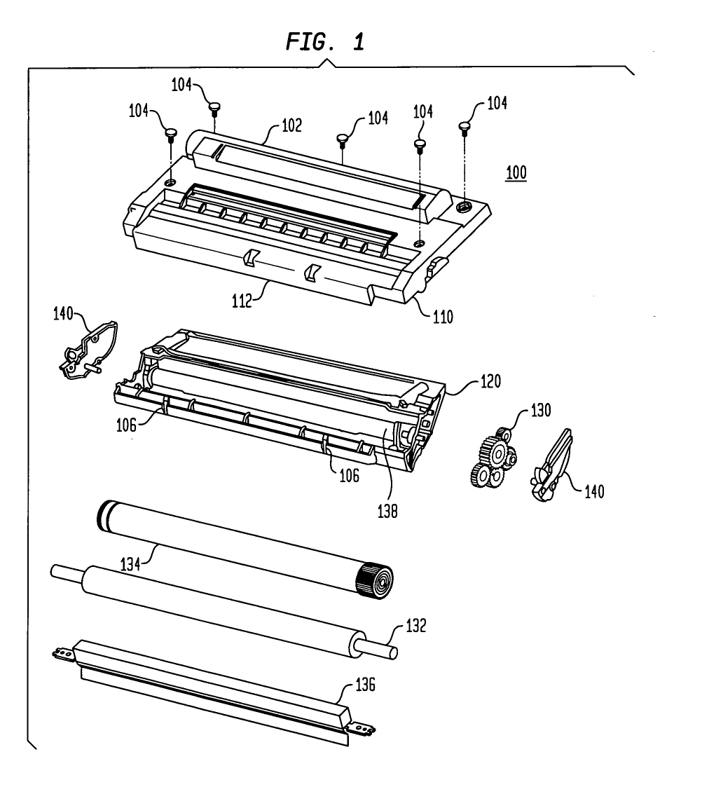

FIG. 1 shows an exploded view of an older style toner cartridge 100. Toner cartridge 100 may be used in the Tally Gencom 922, the Xerox Phaser 3150, the Dell 1600 or the Xerox PE120 family of printers. The toner cartridge 100 fits into any of the aforementioned printers. However, there may be compatibility issues relating to interchanging cartridges between the printers. Even though the cartridge is designed for the Dell 1600 printer, and may fit into a Xerox PE120 printer, it may not function properly in the PE120 printer due to a voltage difference presented to the cartridge. This may cause marginal fusing of toner to the printed material during the printing process. As will be explained further, during the refurbishing process, Xerox PE120 compatible components and toner may be installed into a spent Dell 1600 type cartridge. The cartridge 100 will not fit into a newer style printer such as the Samsung ML-2250 or the Samsung SCX-4720.

The cartridge 100 comprises an upper half 110 and a lower half 120 as well as a toner hopper 102. On the upper half 110 of the toner cartridge 100 is a leading edge 112. When the cartridge 100 is installed into the printer, the leading edge 112 is the first part of the cartridge inserted into the cartridge compartment of the printer. Toner cartridge 100 utilizes toner at about 99.9% efficiency rate. Due to the efficient usage of toner, a waste bin assembly is not required in the toner cartridge 100 collect any excess toner. Any remaining toner left over during the printing process is recycled back into the toner hopper 102.

Although toner cartridge 100 is used to describe the refurbishment process, the refurbishing process can be applied to any cartridge type for any printer cartridge. The first step in the refurbishment process is the separation of the upper half 110 from the lower half 120. After the cartridge two halves 110, 210 are separated, the remanufacturer may access the internal components. The internal components include but are not limited to the gear assembly 130, the PCR 132 (Primary Charge Roller), the OPC 134 (Organic Photo Conductor), the cleaning blade 136 and the developer roller 138. Separating the two halves 110, 120 is accomplished by removing the securing screws 104 located on the upper half 110. After the securing screws 104 are removed, the two locking tabs 106 located on the front of the lower half 120 are depressed. After the locking tabs 106 have been depressed, the upper half 110 may then separated from the lower half 120.

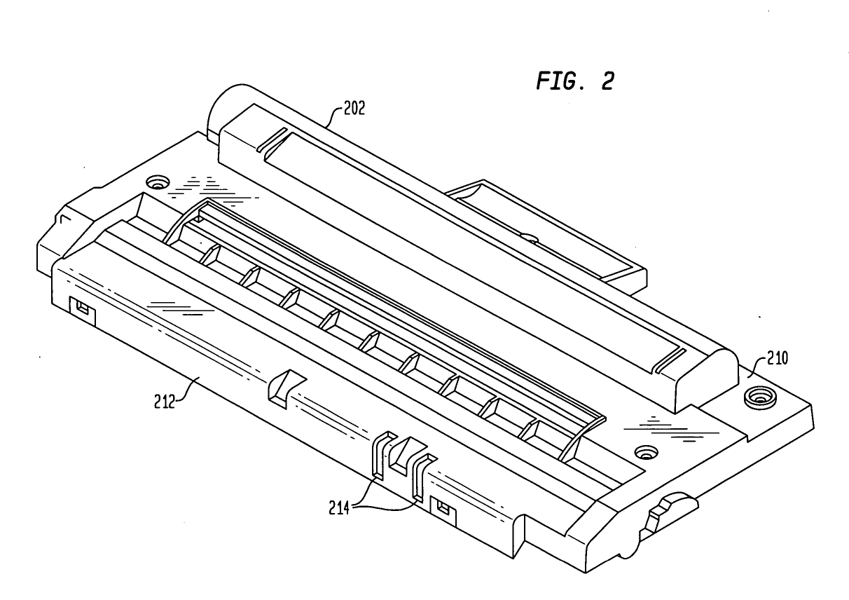

As shown in FIG. 1, there are no key slots on the leading edge 112 of upper half 110. This is in contrast to an upper half 210 of a toner cartridge (not shown) used in the Samsung ML-2250 or the Samsung SCX-4720 as displayed in FIG. 2. The leading edge 212 of upper half 210 comprises two key slots 214 located about two inches from the right edge 260. The Samsung ML-2250 or the Samsung SCX-4720 printer has two fins that protrude into key slots 214 when the cartridge 200 is installed in the printer.

After separating the upper half 110 from the lower half 120 and removing end caps 140, the internal components of the toner cartridge are exposed. During the refurbishment process, the internal components are removed and the upper half 110 and lower half 120 undergo a cleaning process. Typically, the two halves 110, 120 are cleaned out with forced air, removing any remaining toner left inside the cartridge 100.

As discussed previously, toner cartridge 100 does not fit in the Samsung ML-2250 or the Samsung SCX4720 printer due to the fins in the printer's toner cartridge compartment. The present invention provides a way for a toner cartridge remanufacturer to modify upper half 110 to resemble upper half 210. After upper half 210 is modified, the remanufacturer may then reassemble the refurbished cartridge with Samsung ML-2250 or the Samsung SCX-4720 compatible components and offer a refurbished printer cartridge that fits either printer.

In one embodiment of the present invention upper half 110, with is replaced with a pre-molded piece resembling upper half 210 of FIG. 2, when the cartridge is refurbished. In another embodiment, upper half 110 may be modified according to the present invention and reassembled with lower half 120.

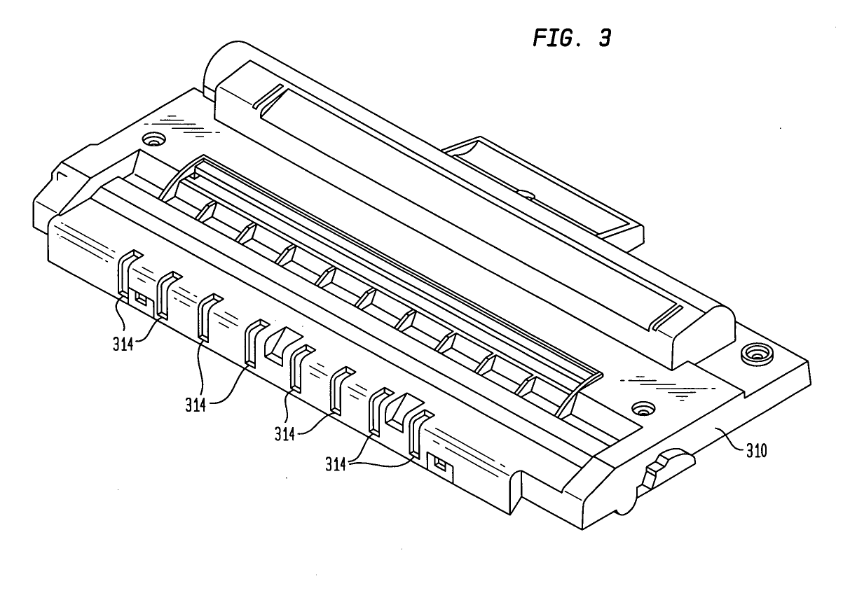

Alternatively, in the embodiment of FIG. 3, multiple key slots 314 may be spaced along a leading edge 312 of an upper half 310. A remanufacturer may add all the possible key slots 314 to the leading edge 112 of cartridge 100 during the conversion process. By adding all applicable key slots 314, the remanufacturer may create an upper half 310 that may be used with any printer family employing a similarly shaped cartridge. Extra key slots 314 do not affect the quality of prints but may provide the remanufacturer with flexibility when offering the various toner cartridge types.

In yet another alternative embodiment, a protrusion may be added to the printer cartridge instead of a key slot. In this instance, the printer may have a sensor or micro switch within the toner cartridge compartment to sense the presence of the protrusion.

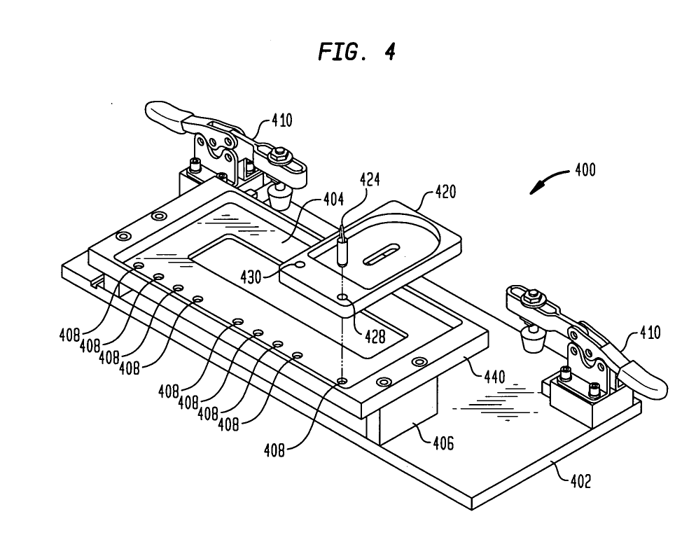

FIG. 4 displays an exploded view of a conversion jig 400 for use with one embodiment of the present invention. The conversion jig 400 comprises a base 402 upon which is mounted a securing bar 404 as well as two securing fixtures 410. The leading edge 112 of toner cartridge 100 is inserted under the securing bar 404. After the leading edge 112 comes in contact with the front portion 406 of the securing bar 404, the toner cartridge 100 is secured into place be lowering the securing fixtures 410 and locking them into place.

After the toner cartridge 100 is secured into place, a conversion template 420 is attached into the securing bar 404. In the embodiment of FIG. 4, the conversion template 420 provides a guide for Rotozip™ tool used to remove a portion of the leading edge 112. Alternatively, a Dremmel™ tool or other type of cutting instrument may be used instead of the Rotozip tool. On the securing bar 404 are guide holes 408 that align with a similar guide holes 428, 430 on the conversion template 420.

The conversion template 420 may be positioned at several different locations on the securing bar 404. This allows the remanufacturer to move the conversion template 420 to the appropriate location of the key slots 220 to be added to toner cartridge 100. In order to convert the upper half 110 to the upper half 210, only two key slots 214 are added.

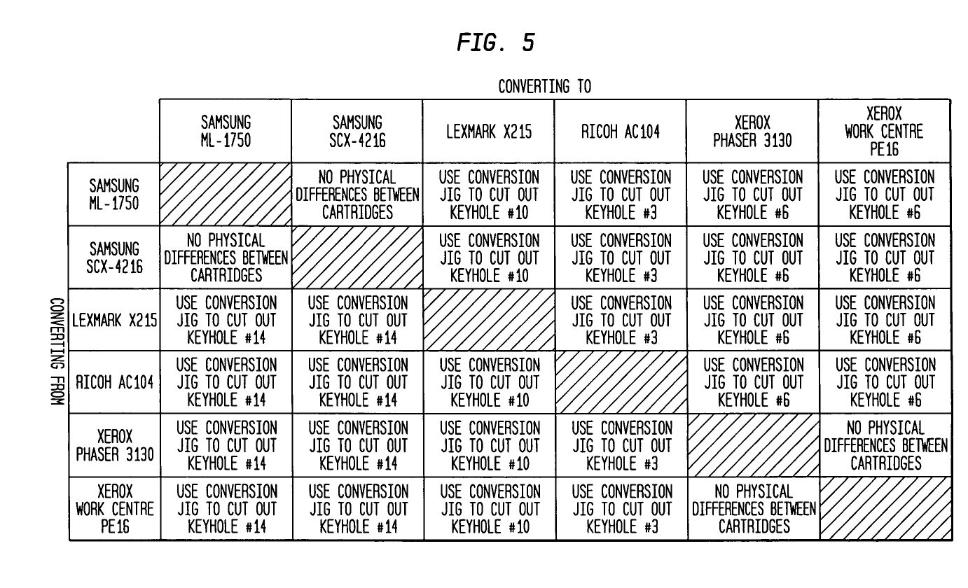

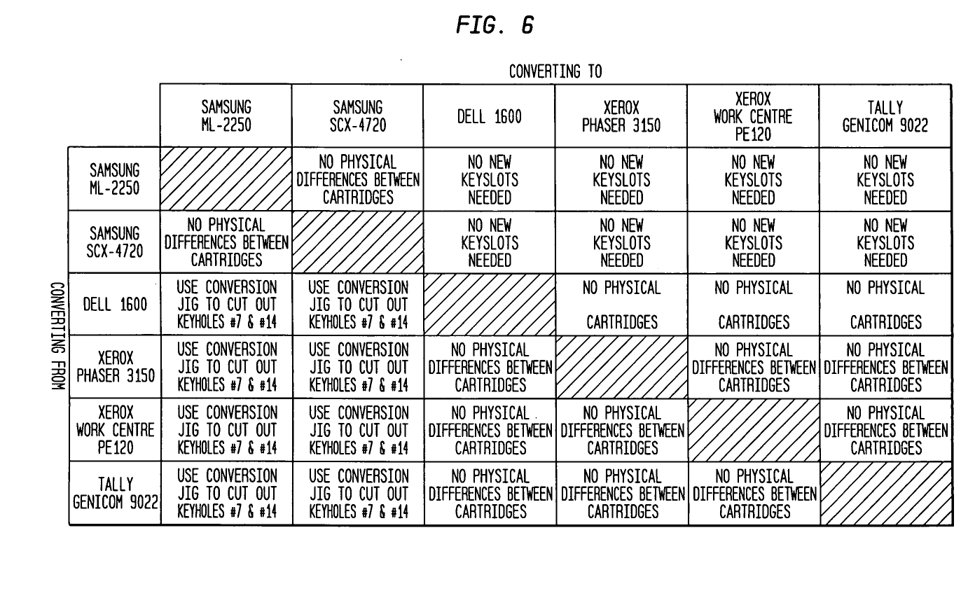

In one embodiment the conversion jig 400 has 14 key slots positions. The key slots positions are numbered 1 to 14 with key slots 1-7 using the right guide hole 228 being located the closest to the right edge 440 of the securing bar 404. Key slots 8-14 use the left guide hole 430. The number and location of key slots being added to the upper half 100 varies depending on the printer manufacturer. FIGS. 5 and 6 display conversion charts describing the cartridge type being converter from/to and the location of the key slots.

The conversion template 220 is secured into place by inserting a quick release pin 424 through the guide holes 428, 430 and 408. The remanufacturer then uses a Rotozip tool to remove a section of the leading edge 112, thus creating a key slot 214. After all the desired key slots 214 are added, a file or other similar device may be used to remove any burrs or other rough edges of the key slots 214.

In the final stage of the refurbishment process, the remanufacturer assembles the toner cartridge using the internal components of the desired product. As previously described, the refurbished cartridge may fit multiple printer types, but each printer type may use unique toner and/or internal components. If the remanufacturer intends to provide a toner cartridge compatible with the Dell 1600 printer, he will use toner specifically designed to be compatible with the Dell 1600 printer.

It is to be understood that the foregoing description has been provided merely for the purpose of explanation and is in no way to be construed as limiting of the invention. Where the invention has been described with reference to embodiments, it is understood that the words which have been used herein are words of description and illustration, rather than words of limitation. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A method of converting an imaging cartridge from one type to another comprising:
providing the imaging cartridge comprising an upper half and a lower half, said imaging cartridge not having a waste bin assembly, said imaging cartridge operable in a first type of imaging device and not operable in a second type of imaging device; and
altering a physical characteristic of said upper half to form an altered imaging cartridge operable in the second type of imaging device.

2. The method of claim 1 wherein said alteration of said physical characteristic comprises creating an indentation in said upper half of the imaging cartridge.

3. The method of claim 2 comprising removing a section of said upper half.

4. The method of claim 1 wherein altering said physical characteristic of said upper half comprises adding a protrusion.

5. The method of claim 1 wherein said imaging cartridge is a toner cartridge.

6. A method of converting an imaging cartridge from one type to another comprising:
providing the imaging cartridge comprising an upper half and a lower half, said imaging cartridge not comprising a waste bin assembly, said imaging cartridge operable in a first type of imaging device and not operable in a second type of imaging device;
separating said upper half from said lower half;
replacing said upper half with a replacement upper half comprising at
least one different physical characteristic than said upper half; and reassembling said imaging cartridge.

7. The method of claim 6 wherein said physical characteristic difference is a depression.

8. The method of claim 6 wherein said physical characteristic difference is a protrusion.

9. The method of claim 6 wherein said imaging cartridge is a toner cartridge.

10. A refurbished imaging cartridge comprising:
a first portion and a second portion, said first portion separable from said second portion, said first portion having different physical characteristics than an original portion, wherein said imaging cartridge does not have a waste bin assembly.

11. The imaging cartridge of claim 10 wherein said first portion is an upper half of said printer cartridge, and said second portion is a lower half of said imaging cartridge.

12. The imaging cartridge of claim 10 wherein said first portion comprises a key slot.
